(19) United States
(12) Patent Application Publication
(10) Pub. No.: US 2026/0316832 A1
(43) Pub. Date: Oct. 15, 2026

(54) REDIRECTED DRIVING IN A FULL-SIZED VEHICLE

(71) Applicant: Toyota Research Institute, Inc., Los Altos, CA (US)

(72) Inventors: Elliot D. Weiss, Palo Alto, CA (US); Hiroshi Yasuda, San Carlos, CA (US)

(73) Assignees: Toyota Research Institute, Inc., Los Altos, CA (US); Toyota Jidosha Kabushiki Kaisha, Toyota-shi Aichi-ken (JP)

(21) Appl. No.: 19/179,045

(22) Filed: Apr. 15, 2025

(51) Int. Cl. B62D 15/02

(52) U.S. Cl. CPC B62D 15/0255

(57) ABSTRACT

A system for causing an occupant of a vehicle to perceive that an actual path of the vehicle is a simulated path of the vehicle can include a processor and a memory. The memory can store a steering module and a communications module. The steering module can include instructions that cause the processor to: (1) receive a first signal indicative of a position of a steering operator interface and (2) produce, based on the first signal, a second signal configured to cause a steering actuator for a wheel to produce, in response to the position of the steering operator interface being associated with causing the vehicle to move along the simulated path, a steering angle for the actual path along which the vehicle is intended to move. The communications module can include instructions that cause the processor to transmit the second signal to the steering actuator.

### TECHNICAL FIELD

The disclosed technologies are directed to causing an occupant of a vehicle to perceive that an actual path of the vehicle is a simulated path of the vehicle.

### BACKGROUND

A process to produce a design for a vehicle can include techniques directed to addressing human factor aspects of the vehicle so that errors made by a human operator of the vehicle can be decreased, safety of an operation of the vehicle can be increased, or both. Human factor aspects of concern can include aspects associated with having the human operator operate the vehicle for one or more of a long distance or a long duration of time. Such aspects can include, for example, fatigue of the human operator, distractions that affect the human operator, or the like.

One technique for obtaining information about such aspects can include monitoring the human operator as the human operator operates the vehicle for one or more of a long distance or a long duration of time. However, although the information obtained using this technique can be based on the human operator operating the vehicle in a real environment and affects that the real environment has on the vehicle (e.g., lateral acceleration, etc.), this technique presumes that a path for such a long-distance operation of the vehicle is available, that such a path includes types of distractions sought to be studied, or the like.

Alternatively, another technique for obtaining information about such aspects can include using a driving simulator. Typically, a driving simulator can include a processor, a display, and one or more car controls (e.g., a steering operator interface, an accelerating operator interface, a braking operator interface, etc.). For example, the driving simulator can cause one or more of a visual representation or an audio representation of objects encountered along a simulated path to be presented via one or more of a display screen or a speaker. However, although the information obtained using this alternative technique can simulate a path for a long-distance operation, the types of distractions sought to be studied, or the like, the information obtained using this alternative technique can lack affects based on the human operator operating the vehicle in a real environment and the affects that the real environment has on the vehicle (e.g., lateral acceleration, etc.).

### SUMMARY

In an embodiment, a system for causing an occupant of a vehicle to perceive that an actual path of the vehicle is a simulated path of the vehicle can include a processor and a memory. The memory can store a steering module and a communications module. The steering module can include instructions that cause the processor to: (1) receive a first signal indicative of a position of a steering operator interface and (2) produce, based on the first signal, a second signal configured to cause a steering actuator for a wheel to produce, in response to the position of the steering operator interface being associated with causing the vehicle to move along the simulated path, a steering angle for the actual path along which the vehicle is intended to move. The communications module can include instructions that cause the processor to transmit the second signal to the steering actuator.

In another embodiment, a method for causing an occupant of a vehicle to perceive that an actual path of the vehicle is a simulated path of the vehicle can include receiving, by a processor, a first signal indicative of a position of a steering operator interface. The method can include producing, by the processor and based on the first signal, a second signal configured to cause a steering actuator for a wheel to produce, in response to the position of the steering operator interface being associated with causing the vehicle to move along the simulated path, a steering angle for the actual path along which the vehicle is intended to move. The method can include transmitting, by the processor, the second signal to the steering actuator.

In another embodiment, a non-transitory computer-readable medium for causing an occupant of a vehicle to perceive that an actual path of the vehicle is a simulated path of the vehicle, the non-transitory computer-readable medium including instructions that, when executed by one or more processors, cause the one or more processors to receive a first signal indicative of a position of a steering operator interface. The non-transitory computer-readable medium can include instructions that, when executed by one or more processors, cause the one or more processors to produce, based on the first signal, a second signal configured to cause a steering actuator for a wheel to produce, in response to the position of the steering operator interface being associated with causing a vehicle to move along a simulated path, a steering angle for an actual path along which the vehicle is intended to move. The non-transitory computer-readable medium can include instructions that, when executed by one or more processors, cause the one or more processors to transmit the second signal to the steering actuator.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 includes a diagram of a first example of an environment of a simulated path of a vehicle, according to the disclosed technologies.

FIG. 2 includes a diagram of a first example of an environment of an actual path, of the vehicle, that corresponds to the first example of the environment of the simulated path, according to the disclosed technologies.

FIG. 3 includes a diagram of a second example of the environment of the simulated path of the vehicle, according to the disclosed technologies.

FIG. 4 includes a diagram of a second example of the environment of the actual path, of the vehicle, that corresponds to the second example of the environment of the simulated path, according to the disclosed technologies.

FIG. 5 includes a diagram of an example of an environment for causing an occupant of the vehicle to perceive that the actual path of the vehicle is the simulated path of the vehicle, according to the disclosed technologies.

FIG. 6 includes a block diagram that illustrates an example of a system for causing the occupant of the vehicle to perceive that the actual path of the vehicle is the simulated path of the vehicle, according to the disclosed technologies.

FIGS. 7A through 7C include a flow diagram that illustrates an example of a method that is associated with causing an occupant of a vehicle to perceive that an actual path of the vehicle is a simulated path of the vehicle, according to the disclosed technologies.

FIG. 8 includes a block diagram that illustrates an example of elements disposed on a vehicle, according to the disclosed technologies.

### DETAILED DESCRIPTION

The disclosed technologies are directed to causing an occupant of a vehicle to perceive that an actual path of the vehicle is a simulated path of the vehicle. Studies have demonstrated that a virtual reality environment can be produced in which a human being perceives that the human being is walking along a simulated path that is a straight path, but the actual path is a circular path. (e.g., producing the virtual reality environment while the human being walks on a treadmill that rotates about a vertical axis). Such a phenomenon can be known as “redirected walking.” The disclosed technologies can produce such a “redirected” phenomenon for the occupant of the vehicle.

A first signal indicative of a position of a steering operator interface can be received. For example, the steering operator interface can include a steering wheel, a yoke, a handlebar, a twin lever steering interface, a joystick-like control lever, or the like. Based on the first signal, a second signal can be produced. The second signal can be configured to cause a steering actuator for a wheel to produce, in response to the position of the steering operator interface being associated with causing a vehicle to move along a simulated path, a steering angle for an actual path along which the vehicle is intended to move. The second signal can be transmitted to the steering actuator. For example, the wheel can include a set of wheels, the steering angle can include a set of steering angles, and the steering actuator can include a set of steering actuators. For example, each wheel, of the set of wheels, can be associated with a corresponding steering actuator of the set of steering actuators. For example, the simulated path can include a straight path, while the actual path can include a circular path. Alternatively, for example, the simulated path can include one or more simulated turns at a first specific angle (e.g., 90 degrees) while the actual path can include one or more actual turns at a second specific angle (e.g., 180 degrees) in which an actual turn, included in the actual path, can be associated with a corresponding simulated turn included in the simulated path.

Additionally, for example, a third signal, based on the first signal, can be produced. For example, the third signal can be configured to cause a steering torque actuator for the steering operator interface to produce, in response to the position of the steering operator interface being associated with causing the vehicle to move along the simulated path, a steering torque having a measurement associated with causing the vehicle to move along the simulated path rather than a measurement associated with causing the vehicle to move along the actual path. For example, the third signal can be transmitted to the steering torque actuator.

Additionally, for example, a fourth signal, based on the first signal, can be produced. For example, the fourth signal can be configured to cause one or more of a display screen or a speaker to produce one or more of a visual representation or an audio representation of objects encountered along the simulated path. For example, the fourth signal can be transmitted to the one or more of the display screen or the speaker.

Advantageously, the disclosed technologies can facilitate obtaining information about aspects associated with having a human operator operate a vehicle for one or more of a long distance or a long duration of time (e.g., fatigue of the human operator, distractions that affect the human operator, or the like) not only in a manner in which the human operator can operate the vehicle in a real environment, perceive affects that the real environment has on the vehicle (e.g., lateral acceleration, etc.), and be presented with information that simulates types of distractions sought to be studied (e.g., objects encountered along the simulated path), but also in a manner in which an area associated with an actual path of the vehicle can be less than an area associated with a situation that would exist if a simulated path of the vehicle was the actual path.

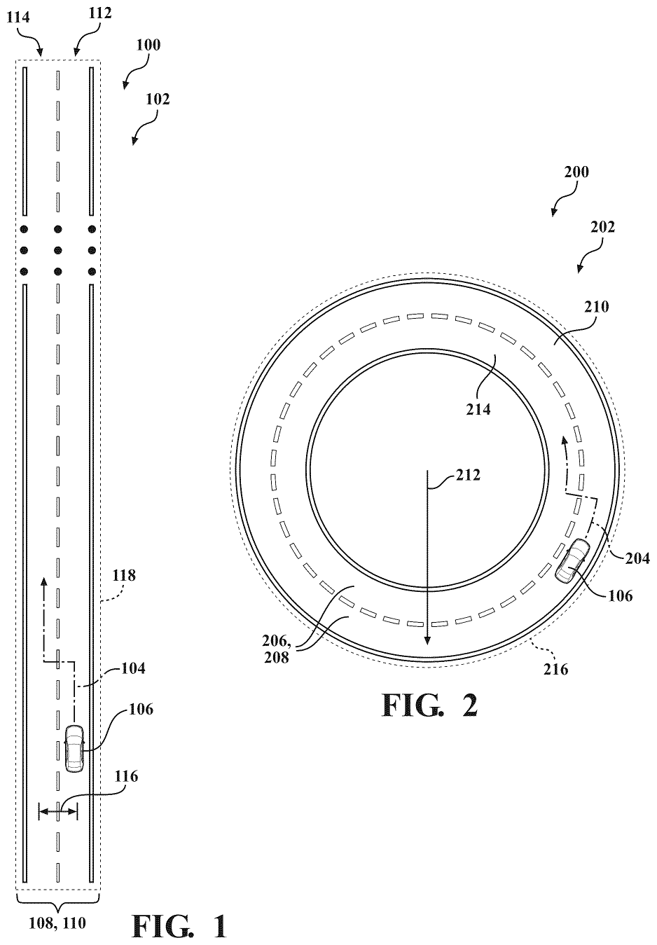

FIG. 1 includes a diagram of a first example 100 of an environment 102 of a simulated path 104 of a vehicle 106, according to the disclosed technologies. The first example 100 can include a straight path 108. For example, the straight path 108 can include a set of parallel lanes 110. For example, the set of parallel lanes 110 can include a first lane 112 and a second lane 114 with a distance 116 between the first lane 112 and the second lane 114. The first example 100 of the simulated path 104 can be associated with an area 118.

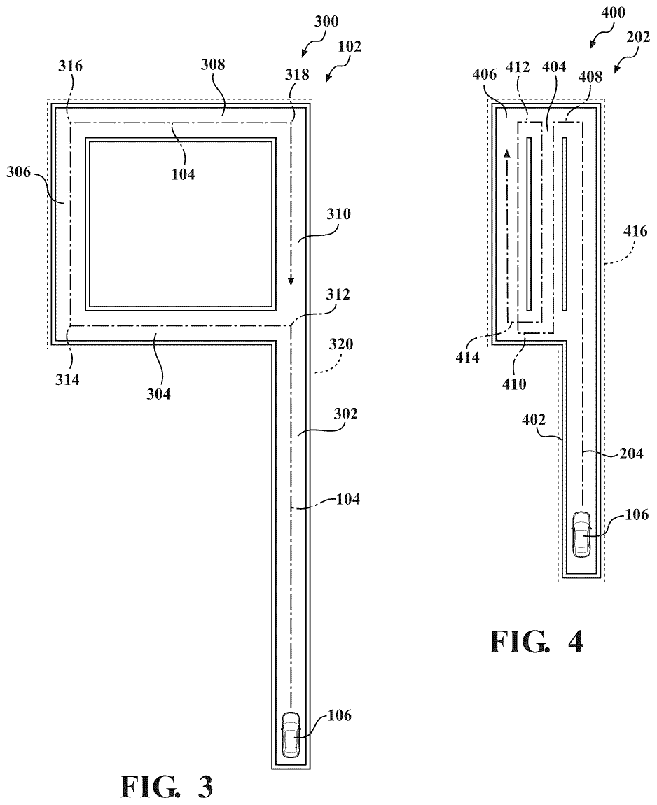

FIG. 2 includes a diagram of a first example 200 of an environment 202 of an actual path 204, of the vehicle 106, that corresponds to the first example 100 of the environment 102 of the simulated path 104, according to the disclosed technologies. The first example 200 can include a circular path 206. For example, the circular path 206 can include a set of concentric circular lanes 208. For example, the set of concentric circular lanes 208 can include a first circular lane 210 with a radius 212 and a second circular lane 214. For example, the first circular lane 210 can be associated with the first lane 112 (illustrated in FIG. 1) and the second circular lane 214 can be associated with the second lane 114 (illustrated in FIG. 1). The first example 200 of the actual path 204 can be associated with an area 216. Because the diagram of the first example 100 of the simulated path 104 (illustrated in FIG. 1) includes ellipses, the area 118 (illustrated in FIG. 1) can be substantially greater than the area 216.

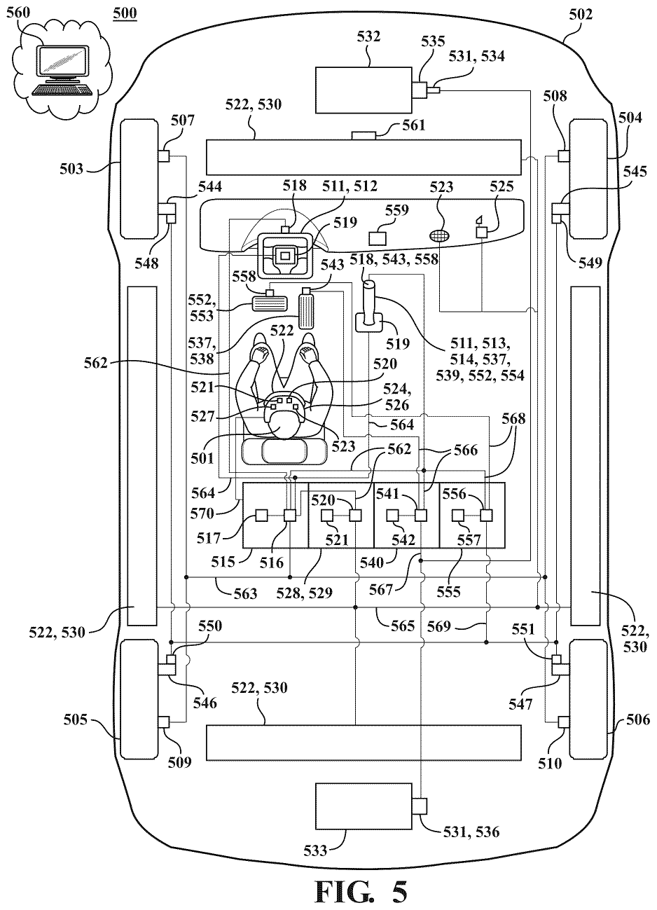

FIG. 3 includes a diagram of a second example 300 of the environment 102 of the simulated path 104 of the vehicle 106, according to the disclosed technologies. The second example 300 can include a first section 302, a second section 304, a third section 306, a fourth section 308, and a fifth section 310. For example, a measurement of a length of the first section 302 can be two city blocks, a measurement of a length of the second section 304 can be one city block, a measurement of a length of the third section 306 can be one city block, a measurement of a length of the fourth section 308 can be one city block, and a measurement of a length of the fifth section 310 can be one city block. In the second example 300, the simulated path 104 can include a first simulated turn 312 at a first specific angle to the left, a second simulated turn 314 at the first specific angle to the right, a third simulated turn 316 at the first specific angle to the right, and a fourth simulated turn 318 at the first specific angle to the right. For example, the first specific angle can be 90 degrees. The second example 300 of the simulated path 104 can be associated with an area 320.

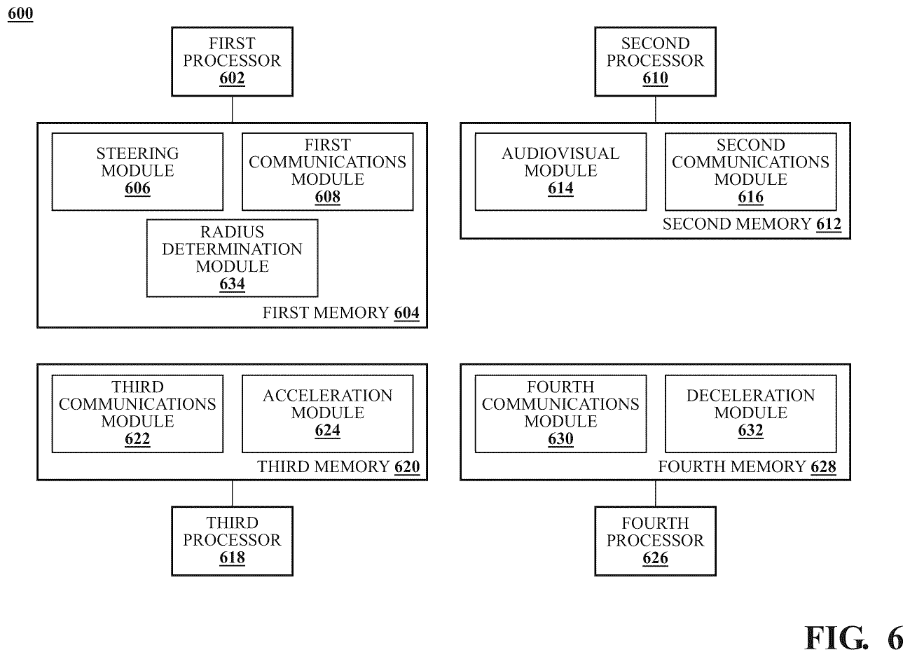

FIG. 4 includes a diagram of a second example 400 of the environment 202 of the actual path 204, of the vehicle 106, that corresponds to the second example 300 of the environment 102 of the simulated path 104, according to the disclosed technologies. The second example 400 can include a first section 402, a second section 404, and a third section 406. For example, a measurement of a length of the first section 402 can be two city blocks, a measurement of a length of the second section 404 can be one city block, and a measurement of a length of the third section 406 can be one city block. In the second example 400, the actual path 204 can include a first actual turn 408 at a second specific angle to the right, a second actual turn 410 at the second specific angle to the right, a third actual turn 412 at the second specific angle to the right, and a fourth actual turn 414 at the second specific turn to the right. For example, the second specific angle can be a multiple of the first specific angle. For example, the multiple can be greater than one or between zero and one. For example, the multiple can have a positive value or a negative value. For example, the multiple can be two and the second specific angle can be 180 degrees. For example, the first actual turn 408 to the left can be associated with the first simulated turn 312 to the left (illustrated in FIG. 3), the second actual turn 410 to the right can be associated with the second simulated turn 314 to the right (illustrated in FIG. 3), the third actual turn 412 to the right can be associated with the third simulated turn 316 to the right (illustrated in FIG. 3), and the fourth actual turn 414 to the right can be associated with the fourth simulated turn 318 to the right (illustrated in FIG. 3). The second example 400 of the actual path 204 can be associated with an area 416. Because: (1) both the first actual turn 408 to the left and the third actual turn 412 to the right are onto the second section 404 (as opposed to separate sections) and (2) both the second actual turn 410 to the right and the fourth actual turn 414 to the right are onto the third section 406 (as opposed to separate sections), the area 416 can be substantially less than the area 320 (illustrated in FIG. 3).

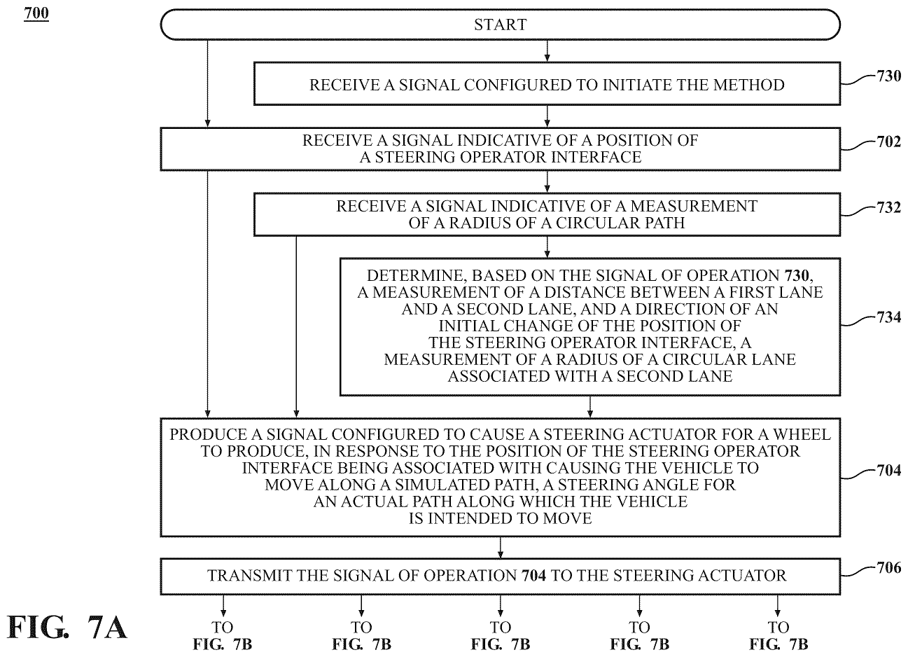

FIG. 5 includes a diagram of an example of an environment 500 for causing an occupant 501 of a vehicle 502 to perceive that an actual path of the vehicle 502 is a simulated path of the vehicle 502, according to the disclosed technologies. For example, the environment 500 can include the vehicle 502. For example, the vehicle 502 can be the vehicle 106 illustrated in FIGS. 1-4.

For example, the vehicle 502 can include a front left wheel 503, a front right wheel 504, a rear left wheel 505, and a rear right wheel 506. For example, the vehicle 502 can include a steering actuator 507, a steering actuator 508, a steering actuator 509, and a steering actuator 510. For example, the steering actuator 507 can be for the front left wheel 503, the steering actuator 508 can be for the front right wheel 504, the steering actuator 509 can be for the rear left wheel 505, and the steering actuator 510 can be for the rear right wheel 506. For example, the vehicle 502 can include a steering operator interface 511. A first example 512 of the steering operator 7 interface 511 can include a steering wheel, a yoke, a handlebar, a twin lever steering interface, or the like. Alternatively, a second example 513 of the steering operator interface 511 can include a joystick-like control lever 514. For example, the vehicle 502 can include an electronic control unit (ECU) 515. For example, the ECU 515 can house a processor 516 and a memory 517. For example, the ECU 515 can be configured to operate a steer-by-wire system. For example, the vehicle 502 can include a position sensor 518 for the steering operator interface 511. For example, the vehicle 502 can include a steering torque actuator 519 for the steering operator interface 511. For example, the steering torque actuator 519 can be a component of the steer-by-wire system.

Additionally, for example, the environment 500 can include a processor 520, a memory 521, and one or more of a display screen 522 or a speaker 523. In a first example 524: (1) the vehicle 502 can include a wireless communications device 525 and (2) a virtual reality (VR) headset 526 can include a wireless communications device 527, the processor 520, the memory 521, and the one or more of the display screen 522 or the speaker 523. For example, the occupant 501 can wear the VR headset 526. In a second example 528, the vehicle 502 can include an ECU 529 and the one or more of the display screen 522 or the speaker 523. For example, the ECU 529 can house the processor 520 and the memory 521. For example, the display screen 522 can include a set of display screens 522, the vehicle 502 can include a set of windows 530, and each window 530, of the set of windows 530, can be covered by a corresponding display screen 522 of the set of display screens 522.

Additionally, for example, the vehicle 502 can include an acceleration control device 531 and one or more of an internal combustion engine 532 or an electric vehicle battery 533. For example, the acceleration control device 531 can include one or more of a control device 534 configured to control a position of a throttle 535 for the internal combustion engine 532 or a motor controller 536 configured to control an amount of current conveyed from the electric vehicle battery 533. For example, the vehicle 502 can include an accelerating operator interface 537. A first example 538 of the accelerating operator interface 537 can include an accelerator pedal. A second example 539 of the accelerating operator interface 537 can include the joystick-like control lever 514. For example, the vehicle 502 can include an ECU 540. For example, the ECU 540 can house a processor 541 and a memory 542. For example, the ECU 540 can be configured to operate a drive-by-wire system. For example, the vehicle 502 can include a position sensor 543 for the accelerating operator interface 537.

Additionally, for example, the vehicle 502 can include a brake 544, a brake 545, a brake 546, and a brake 547. For example, the brake 544 can be for the front left wheel 503, the brake 545 can be for the front right wheel 504, the brake 546 can be for the rear left wheel 505, and the brake 547 can be for the rear right wheel 506. For example, the vehicle 502 can include a braking actuator 548, a braking actuator 549, a braking actuator 550, and a braking actuator 551. For example, the braking actuator 548 can be for the brake 544, the braking actuator 549 can be for the brake 545, the braking actuator 550 can be for the brake 546, and the braking actuator 548 can be for the brake 547. For example, the vehicle 502 can include a braking operator interface 552. A first example 553 of the braking operator interface 552 can include a brake pedal. A second example 554 of the braking operator interface 552 can include the joystick-like control lever 514. For example, the vehicle 502 can include an ECU 555. For example, the ECU 555 can house a processor 556 and a memory 557. For example, the ECU 555 can be configured to operate a brake-by-wire system. For example, the vehicle 502 can include a position sensor 558 for the braking operator interface 552.

Additionally, for example, the vehicle 502 can include a user interface 559.

Additionally, for example, the environment 500 can include a server 560.

Additionally, for example, the vehicle 502 can include an environment sensor 561. For example, the environment sensor 561 can include one or more imaging devices or ranging devices. Imaging devices can include, for example, a camera, a color camera, a stereoscopic camera, a video camera, a digital video camera, or the like. Ranging devices can include, for example, ultrasonic imaging devices, infrared imaging devices, radar devices, lidar devices, ultrasonic ranging devices, infrared ranging devices, or the like.

For example, the position sensor 518 can be configured to produce a signal 562 and to transmit the signal 562 to the processor 516. For example, the processor 516 can be configured to receive the signal 562 from the position sensor 518. For example, the processor 516 can be configured to produce a signal 563 and to transmit the signal 563 to one or more of the steering actuator 507, the steering actuator 508, the steering actuator 509, or the steering actuator 510. For example, the processor 516 can be configured to produce a signal 564 and to transmit the signal 564 to the steering torque actuator 519. For example, the processor 516 can be configured to transmit the signal 562 to the processor 520. For example, the processor 516 can be configured to transmit, via the wireless communications device 525 and the wireless communications device 527, the signal 562 to the processor 520. For example, the processor 520 can be configured to produce a signal 565 and to transmit the signal 565 to the one or more of the display screen 522 or the speaker 523. For example, the position sensor 543 can be configured to produce a signal 566 and to transmit the signal 566 to the processor 541. For example, the processor 541 can be configured to produce a signal 567 and to transmit the signal 567 to one or more of the control device 534 or the motor controller 536. For example, the position sensor 558 can be configured to produce a signal 568 and to transmit the signal 568 to the processor 556. For example, the processor 556 can be configured to produce a signal 569 and to transmit the signal 569 to one or more of the braking actuator 548, the braking actuator 549, the braking actuator 550, or the braking actuator 551. In a first example, the user interface 559 can be configured to produce a signal (not illustrated) and to transmit this signal to one or more of the processor 516, the processor 520, the processor 541, or the processor 556. In a second example, the server 560 can be configured to produce this signal and to transmit, via the wireless communications device 525, this signal to the one or more of the processor 516, the processor 520, the processor 541, or the processor 556. In a first example, the user interface 559 can be configured to produce a signal (not illustrated) and to transmit this signal to the processor 516. In a second example, the server 560 can be configured to produce this signal and to transmit, via the wireless communications device 525, this signal to the processor 516. For example, a cable 570 can be connected to the ECU 515 and can be configured to be connected to the VR headset 526.

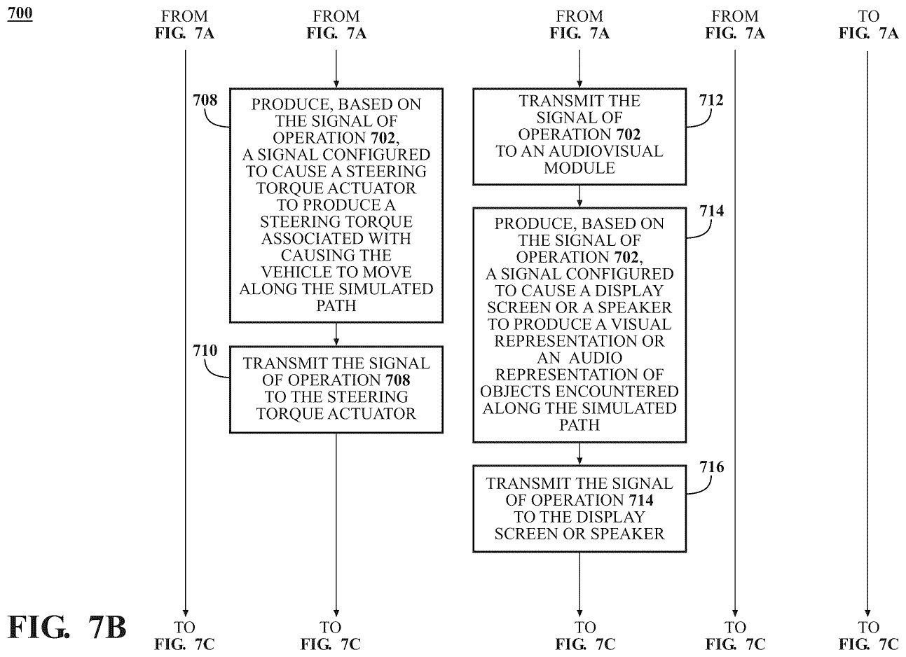

FIG. 6 includes a block diagram that illustrates an example of a system 600 for causing an occupant of a vehicle to perceive that an actual path of the vehicle is a simulated path of the vehicle, according to the disclosed technologies. The system 600 can include, for example, a first processor 602 and a first memory 604. The first memory 604 can be communicably coupled to the first processor 602. For example, the first memory 604 can store a steering module 606 and a first communications module 608.

For example, the steering module 606 can include instructions that function to control the first processor 602 to receive a first signal indicative of a position of a steering operator interface. For example, a position sensor for the steering operator interface can be configured to produce the first signal and to transmit the first signal to the first processor 602. With reference to FIG. 5, for example, the first processor 602 can be the processor 516, the first memory 604 can be the memory 517, the first signal can be the signal 562, the steering operator interface can be the steering operator interface 511, and the position sensor can be the position sensor 518.

Returning to FIG. 6, for example, the steering module 606 can include instructions that function to control the first processor 602 to produce, based on the first signal, a second signal. For example, the second signal can be configured to cause a steering actuator for a wheel to produce, in response to the position of the steering operator interface being associated with causing a vehicle to move along a simulated path, a steering angle for an actual path along which the vehicle is intended to move. With reference to FIGS. 1-5, for example, the second signal can be the signal 563, the steering actuator can be one or more of the steering actuator 507, the steering actuator 508, the steering actuator 509, or the steering actuator 510, the wheel can be one or more of the front left wheel 503, the front right wheel 504, the rear left wheel 505, or the rear right wheel 506, the steering operator interface can be the steering operator interface 511, the simulated path can be the simulated path 104, and the actual path can be the actual path 204.

Returning to FIG. 6, for example, the first communications module 608 can include instructions that function to control the first processor 602 to transmit the second signal to the steering actuator.

For example, the first processor 602 can be housed in a first electronic control unit (ECU). For example, the first ECU can be configured to operate a steer-by-wire system. For example, the steering operator interface can include a steering wheel, a yoke, a handlebar, a twin lever steering interface, a joystick-like control lever, or the like. With reference to FIG. 5, for example, the first ECU can be the ECU 515 and the steering operator interface can include the first example 512 of the steering operator interface 511 or the second example 513 of the steering operator interface 511, which can include the joystick-like control lever 514.

Returning to FIG. 6, for example: (1) the wheel can include a set of wheels, (2) the steering angle can include a set of steering angles, (3) the steering actuator can include a set of steering actuators, and (4) the steering each wheel, of the set of wheels, can be associated with a corresponding steering actuator of the set of steering actuators.

For example: (1) the set of wheels can include a front left wheel of the vehicle and a front right wheel of the vehicle, (2) the set of steering actuators can include a first steering actuator and a second steering actuator, and (3) the set of steering angles can include a first steering angle and a second steering angle. For example, the first steering actuator can be for the front left wheel and the second steering actuator can be for the front right wheel. For example, the first steering angle can be for the front left wheel and the second steering angle can be for the front right wheel. For example, the first steering actuator and the second steering actuator can be configured so that the first steering angle and the second steering angle comply with Ackermann steering geometry. Alternatively, for example, the first steering angle, controlled by the first steering actuator, can be independent of the second steering angle controlled by the second steering actuator.

Alternatively, the vehicle can be capable of four-wheel steering. For example: (1) the set of wheels can further include a rear left wheel of the vehicle and a rear right wheel of the vehicle, (2) the set of steering actuators can further include a third steering actuator and a fourth steering actuator, and (3) the set of steering angles can further include a third steering angle and a fourth steering angle. For example, the third steering actuator can be for the rear left wheel and the fourth steering actuator can be for the rear right wheel. For example, the third steering angle can be for the rear left wheel and the fourth steering angle can be for the rear right wheel. For example, the third steering actuator and the fourth steering actuator can be configured so that the third steering angle and the fourth steering angle comply with Ackermann steering geometry. Alternatively, for example, the third steering angle, controlled by the third steering actuator, can be independent of the fourth steering angle controlled by the fourth steering actuator. For example, the first steering angle, the second steering angle, the third steering angle, and the fourth steering angle can be configured so that: (1) a difference between: (a) a lateral acceleration of the vehicle on the actual path and (b) a lateral acceleration of the vehicle on the simulated path can be: (1) less than: (a) a threshold lateral acceleration greater than (b) a lateral acceleration of the vehicle in a situation in which: (i) the simulated path is the actual path, but (ii) the third steering angle is zero degrees and the fourth steering angle is zero degrees (e.g., a two-wheel steering situation). For example, studies have demonstrated that the occupant of the vehicle will not perceive the difference if the difference is less than the threshold lateral acceleration greater than the lateral acceleration of the vehicle in the situation in which the simulated path is the actual path and the vehicle is using two-wheel steering.

Additionally, for example, system 600 can provide vestibular feedback to an operator of the vehicle. For example, the steering module 606 can include instructions that function to control the first processor 602 to produce, based on the first signal, a third signal. For example, the third signal can be configured to cause a steering torque actuator for the steering operator interface to produce, in response to the position of the steering operator interface being associated with causing the vehicle to move along the simulated path, a steering torque having a measurement associated with causing the vehicle to move along the simulated path rather than a measurement associated with causing the vehicle to move along the actual path. For example, the steering torque actuator can be a component of the steer-by-wire system. With reference to FIG. 5, for example, the second signal can be the signal 564 and the steering torque actuator can be the steering torque actuator 519.

Returning to FIG. 6, for example, the first communications module 608 can include instructions that function to control the first processor 602 to transmit the third signal to the steering torque actuator.

Additionally, for example, the system 600 can include a second processor 610 and a second memory 612. The second memory 612 can be communicably coupled to the second processor 610. For example, the second memory 612 can store an audiovisual module 614 and a second communications module 616.

For example, the first communications module 608 can further includes instructions to transmit the first signal to the second processor 610.

For example, the audiovisual module 614 can include instructions that function to control the second processor 610 to produce, based on the first signal, a fourth signal. For example, the fourth signal can be configured to cause one or more of a display screen or a speaker to produce one or more of a visual representation or an audio representation of objects encountered along the simulated path. For example, the one or more of the visual representation or the audio representation can include a virtual reality (VR) representation. For example, a purpose of the VR representation can be to cause the occupant to perceive the actual path of the vehicle to be the simulated path of the vehicle by isolating the occupant from objects that would be encountered along the actual path. In a first variation of a first example: (1) the vehicle can include a wireless communications device and (2) a VR headset can include a wireless communications device, the second processor 610, the second memory 612, and the one or more of the display screen or the speaker. For example, the occupant can wear the VR headset. For example, the wireless communications device included in the vehicle can be communicably coupled to the first processor 602 and the wireless communications device included in the VR headset can be communicably coupled to the second processor 610. For example, the instructions to transmit the first signal to the second processor 610 can include instructions to transmit, via the wireless communications device included in the vehicle and the wireless communications device included in the VR headset, the first signal to the second processor 610. In a second variation of the first example, a cable can be connected to the first processor 602 and can be configured to be connected to the second processor 610 included in the VR headset. For example, the instructions to transmit the first signal to the second processor 610 can include instructions to transmit, via the cable, the first signal to the second processor 610. In a second example, the vehicle 502 can include a second ECU and the one or more of the display screen or the speaker. For example, the second ECU can house the second processor 610 and the second memory 612. For example: (1) the display screen can include a set of display screens, (2) the vehicle can include a set of windows, and (3) each window, of the set of windows, can be covered by a corresponding display screen of the set of display screens. For example, each display screen can cover a corresponding window in a manner that causes the occupant to perceive the actual path of the vehicle to be the simulated path of the vehicle by isolating the occupant from objects that would be encountered along the actual path. With reference to FIG. 5, for example, the second processor 610 can be the processor 520, the second memory 612 can be the memory 521, the fourth signal can be the signal 565, the display screen can be the display screen 522, the speaker can be the speaker 523, the VR headset can be the VR headset 526, the wireless communications device included in the vehicle can be the wireless communications device 525, the wireless communications device included in the VR headset can be the wireless communications device 527, the second ECU can be the ECU 529, the set of windows can be the set of windows 530, and the cable can be the cable 570.

Returning to FIG. 6, for example, the second communications module 616 can include instructions that function to control the second processor 610 to transmit the fourth signal to the one or more of the display screen or the speaker.

Additionally, for example, the system 600 can include a third processor 618 and a third memory 620. The third memory 620 can be communicably coupled to the third processor 618. For example, the third memory 620 can store a third communications module 622 and an acceleration module 624.

For example, the third communications module 622 can include instructions that function to control the third processor 618 to receive a fifth signal indicative of a position of an accelerating operator interface. For example, a position sensor for the accelerating operator interface can be configured to produce the fifth signal and to transmit the fifth signal to the third processor 618. With reference to FIG. 5, for example, the third processor 618 can be the processor 541, the third memory 620 can be the memory 542, the fifth signal can be the signal 566, the accelerating operator interface can be the accelerating operator interface 537, and the position sensor can be the position sensor 543.

Returning to FIG. 6, for example, the third communications module 622 can include instructions that function to control the third processor 618 to transmit a sixth signal to an acceleration control device. With reference to FIG. 5, for example, the sixth signal can be the signal 567 and the acceleration control device can be the acceleration control device 531.

Returning to FIG. 6, for example, the acceleration module 624 can include instructions that function to control the third processor 618 to produce, based on the fifth signal, the sixth signal. For example, the sixth signal can be configured to control the acceleration control device to cause, in response to the position of the accelerating operator interface being associated with causing the vehicle to move at a first rate of acceleration, the vehicle to move at a second rate of acceleration.

With reference to FIGS. 1-4 and 6, for example, because the actual path of the vehicle (e.g., the actual path 204 illustrated in FIGS. 2 and 4) can include one or more of sharper curves or sharper turns than the simulated path of the vehicle (e.g., the simulated path 104 illustrated in FIGS. 1 and 3), the second rate of acceleration can be slower than the first rate of acceleration so that the occupant of the vehicle can be less likely to perceive lateral accelerations associated with the actual path being different from the simulated path. Additionally, for example, one or more operations of the system 600 may occur for a duration of time greater than a duration threshold so that the occupant can perceive the simulated reality to be the actual reality. For example, the duration threshold can be about thirty minutes. During this duration of time, for example, the simulated reality can become familiar to the occupant so that the simulated reality no longer seems unusual and can be accepted as normal. During this duration of time, for example, a speed of the vehicle can be gradually reduced so that subsequent changes in speed can include a slower range of speeds so that, again, the occupant of the vehicle can be less likely to perceive lateral accelerations associated with the actual path being different from the simulated path.

For example, the third processor 618 can be housed in a third ECU. For example, the third ECU can be configured to operate a drive-by-wire system. For example, the accelerating operator interface can include an accelerator pedal, a joystick-like control lever, or the like. For example, the acceleration control device can include one or more of a control device configured to control a position of a throttle for an internal combustion engine or a motor controller configured to control an amount of current conveyed from an electric vehicle battery. With reference to FIG. 5, for example, the third ECU can be the ECU 540, the accelerator pedal can be the first example 538 of the accelerating operator interface 537, the joystick-like control lever can be the joystick-like control lever 514, the control device configured to control the position of the throttle for the internal combustion engine can be the control device 534 configured to control the position of the throttle 535 for the internal combustion engine 532, and the motor controller configured to control the amount of current conveyed from the electric vehicle battery can be the motor controller 536 configured to control the amount of current conveyed from the electric vehicle battery 533.

Returning to FIG. 6, additionally, for example, the system 600 can include a fourth processor 626 and a fourth memory 628. The fourth memory 628 can be communicably coupled to the fourth processor 626. For example, the fourth memory 628 can store a fourth communications module 630 and a deceleration module 632.

For example, the fourth communications module 630 can include instructions that function to control the fourth processor 626 to receive a seventh signal indicative of a position of a braking operator interface. For example, a position sensor for the braking operator interface can be configured to produce the seventh signal and to transmit the seventh signal to the fourth processor 626. With reference to FIG. 5, for example, the fourth processor 626 can be the processor 556, the fourth memory 628 can be the memory 557, the seventh signal can be the signal 568, the braking operator interface can be the braking operator interface 552, and the position sensor can be the position sensor 558.

Returning to FIG. 6, for example, the fourth communications module 630 can include instructions that function to control the fourth processor 626 to transmit an eighth signal to one or more of the braking actuators for one or more brakes. With reference to FIG. 5, for example, the eighth signal can be the signal 569 and the one or more of the braking actuators for the one or more brakes can be the braking actuator 548 for the brake 544, the braking actuator 549 for the brake 545, the braking actuator 550 for the brake 546, and the braking actuator 548 for the brake 547.

Returning to FIG. 6, for example, the deceleration module 632 can include instructions that function to control the fourth processor 626 to produce, based on the seventh signal, the eighth signal. For example, the sixth signal can be configured to cause the one or more braking actuators to cause, in response to the position of the braking operator interface being associated with causing the vehicle to move at a first rate of deceleration, the vehicle to move at a second rate of deceleration.

With reference to FIGS. 1-4 and 6, for example, because the actual path of the vehicle (e.g., the actual path 204 illustrated in FIGS. 2 and 4) can include one or more of sharper curves or sharper turns than the simulated path of the vehicle (e.g., the simulated path 104 illustrated in FIGS. 1 and 3), the second rate of deceleration can be slower than the first rate of deceleration so that the occupant of the vehicle can be less likely to perceive lateral accelerations associated with the actual path being different from the simulated path. Additionally, for example, one or more operations of the system 600 may occur for a duration of time greater than a duration threshold so that the occupant can perceive the simulated reality to be the actual reality. For example, the duration threshold can be about thirty minutes. During this duration of time, for example, the simulated reality can become familiar to the occupant so that the simulated reality no longer seems unusual and can be accepted as normal. During this duration of time, for example, a speed of the vehicle can be gradually reduced so that subsequent changes in speed can include a slower range of speeds so that, again, the occupant of the vehicle can be less likely to perceive lateral accelerations associated with the actual path being different from the simulated path.

For example, the fourth processor 626 can be housed in a fourth ECU. For example, the fourth ECU can be configured to operate a brake-by-wire system. For example, the decelerating operator interface can include a brake pedal, a joystick-like control lever, or the like. With reference to FIG. 5, for example, the fourth ECU can be the ECU 555, the accelerator pedal can be the first example 553 of the braking operator interface 552, and the joystick-like control lever can be the joystick-like control lever 514.

Returning to FIG. 6, for example, one or more of the first communications module 608, the second communications module 616, the third communications module 622, or the fourth communications module 630 can further include instructions to receive a ninth signal configured to initiate operations of the system 600. In a first example, a user interface can be configured to produce the ninth signal and to transmit the ninth signal to the one or more of the first communications module 608, the second communications module 616, the third communications module 622, or the fourth communications module 630. In a second example, a server can be configured to produce the ninth signal and to transmit, via a wireless communications device included in the vehicle, the ninth signal to the one or more of the first communications module 608, the second communications module 616, the third communications module 622, or the fourth communications module 630. With reference to FIG. 5, for example, the ninth signal can be one of the signals produced by the user interface 559 or the server 560, the user interface can be the user interface 559, the server can be the server 560, and the wireless communications device included in the vehicle can be the wireless communications device 525. As described above, for example, one or more operations of the system 600 may occur for a duration of time greater than a duration threshold so that the occupant of the vehicle can perceive the simulated reality to be the actual reality. For example, the duration threshold can be about thirty minutes. During this duration of time, for example, the simulated reality can become familiar to the occupant so that the simulated reality no longer seems unusual and can be accepted as normal.

Returning to FIG. 6, for example, in an implementation of the system 600, the simulated path can include a straight path, and the actual path can include a circular path. With reference to FIGS. 1 and 2, for example, the simulated path can be the first example 100 of the simulated path 104 and the actual path can be the first example 200 of the actual path 204. Returning to FIG. 6, for example, the first communications module 608 can further include instructions to receive a tenth signal indicative of a measurement of a radius of the circular path. For example, the instructions to produce the second signal can include instructions to produce, based on the first signal (the position of the steering operator interface) and the tenth signal (the measurement of the radius of the circular path), the second signal (configured to cause the steering actuator to produce the steering angle for the actual path). In a first example, a user interface can be configured to produce the tenth signal and to transmit the tenth signal to the first communications module 608. In a second example, a server can be configured to produce the tenth signal and to transmit, via a wireless communications device included in the vehicle, the tenth signal to the first communications module 608. With reference to FIGS. 2 and 5, for example, the first signal can be the signal 562, the second signal can be the signal 563, the tenth signal can be one of the signals produced by the user interface 559 or the server 560, the radius can be the radius 212, the user interface can be the user interface 559, the server can be the server 560, and the wireless communications device included in the vehicle can be the wireless communications device 525.

For example: (1) the straight path can include a set of parallel lanes, (2) the circular path can include a set of concentric circular lanes, and (3) each circular lane, of the set of concentric circular lanes, can be associated with a corresponding lane of the set of parallel lanes. With reference to FIGS. 1 and 2, for example: (1) the set of parallel lanes can be the first lane 112 and the second lane 114, (2) the set of concentric circular lanes can be the first circular lane 210 and the second circular lane 214, and (3) the first circular lane 210 can be associated with the first lane 112 and the second circular lane 214 can be associated with the second lane 114.

For example, the simulated path, in response to changes of the position of the steering operator interface, can further include a change from a first lane, of the set of parallel lanes, to a second lane of the set of parallel lanes. With reference to FIG. 1, for example, the simulated path 104 can change from the first lane 112 to the second lane 114. Returning to FIG. 6, for example, the first memory 604 can further store a radius determination module 634. For example, the radius determination module 634 can include instructions that function to control the first processor 602 to determine, based on the tenth signal, a measurement of a distance between the first lane and the second lane, and a direction of an initial change of the changes of the position of the steering operator interface, a measurement of a radius of a circular lane associated with the second lane. For example, the instructions to produce the second signal can include instructions to produce, based on the first signal (the position of the steering operator interface) and one or more of the tenth signal (the measurement of the radius of the circular path) or the measurement of the radius of the circular lane associated with the second lane, the second signal (configured to cause the steering actuator to produce the steering angle for the actual path). With reference to FIGS. 1, 2, and 5, for example, the distance between the first lane and the second lane can be the distance 116. For example, the measurement of the distance between the first lane and the second lane can be determined from information received from the environment sensor 561. For example, the direction of the initial change of the changes of the position of the steering operator interface can be a left direction. Because the first circular lane 210 can be associated with the first lane 112 and the second circular lane 214 can be associated with the second lane 114, the direction of the initial change being the left direction can be indicative that the measurement of the radius of the second circular lane 214, associated with the second lane 114, is smaller than the measurement of the radius of the first circular lane 210, associated with the first lane 112. In this manner, the measurement of the radius of the second circular lane 214 can be determined.

Returning to FIG. 6, for example, in an implementation of the system 600: (1) the simulated path can include one or more simulated turns at a first specific angle (e.g., 90 degrees), (2) the actual path can include one or more actual turns at a second specific angle (e.g., 180 degrees), and (3) an actual turn, included in the actual path, can be associated with a corresponding simulated turn included in the simulated path. With reference to FIGS. 3 and 4, for example: (1) the simulated path can be the simulated path 104, (2) the actual path can be the actual path 204, and (3) the first actual turn 408 to the left can be associated with the first simulated turn 312 to the left, the second actual turn 410 to the right can be associated with the second simulated turn 314 to the right, the third actual turn 412 to the right can be associated with the third simulated turn 316 to the right, and the fourth actual turn 414 to the right can be associated with the fourth simulated turn 318 to the right.

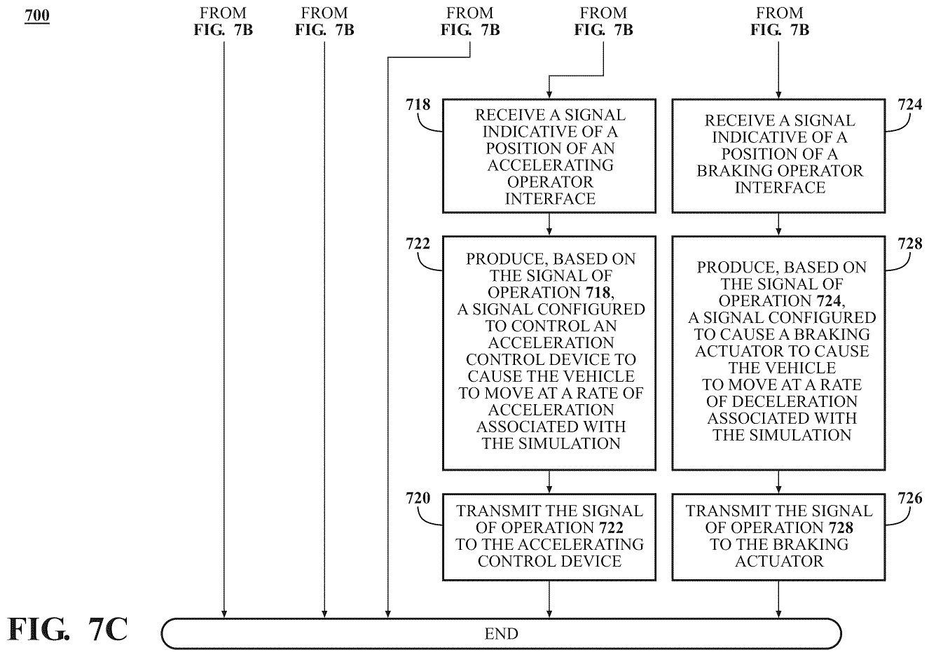

FIGS. 7A through 7C include a flow diagram that illustrates an example of a method 700 that is associated with causing an occupant of a vehicle to perceive that an actual path of the vehicle is a simulated path of the vehicle, according to the disclosed technologies. Although the method 700 is described in combination with the system 600 illustrated in FIG. 6, one of skill in the art understands, in light of the description herein, that the method 700 is not limited to being implemented by the system 600 illustrated in FIG. 6. Rather, the system 600 illustrated in FIG. 6 is an example of a system that may be used to implement the method 700. Additionally, although the method 700 is illustrated as a generally serial process, various aspects of the method 700 may be able to be executed in parallel.

In FIG. 7A, in the method 700, at an operation 702, for example, the steering module 606 can receive a first signal indicative of a position of a steering operator interface. For example, a position sensor for the steering operator interface can be configured to produce the first signal and to transmit the first signal to the steering module 606.

At an operation 704, for example, the steering module 606 can produce, based on the first signal, a second signal. For example, the second signal can be configured to cause a steering actuator for a wheel to produce, in response to the position of the steering operator interface being associated with causing the vehicle to move along the simulated path, a steering angle for the actual path along which the vehicle is intended to move.

At an operation 706, for example, the first communications module 608 can transmit the second signal to the steering actuator.

For example, the first processor 602 can be housed in a first electronic control unit (ECU). For example, the first ECU can be configured to operate a steer-by-wire system. For example, the steering operator interface can include a steering wheel, a yoke, a handlebar, a twin lever steering interface, a joystick-like control lever, or the like.

For example: (1) the wheel can include a set of wheels, (2) the steering angle can include a set of steering angles, (3) the steering actuator can include a set of steering actuators, and (4) the steering each wheel, of the set of wheels, can be associated with a corresponding steering actuator of the set of steering actuators.

For example: (1) the set of wheels can include a front left wheel of the vehicle and a front right wheel of the vehicle, (2) the set of steering actuators can include a first steering actuator and a second steering actuator, and (3) the set of steering angles can include a first steering angle and a second steering angle. For example, the first steering actuator can be for the front left wheel and the second steering actuator can be for the front right wheel. For example, the first steering angle can be for the front left wheel and the second steering angle can be for the front right wheel. For example, the first steering actuator and the second steering actuator can be configured so that the first steering angle and the second steering angle comply with Ackermann steering geometry. Alternatively, for example, the first steering angle, controlled by the first steering actuator, can be independent of the second steering angle controlled by the second steering actuator.

Alternatively, the vehicle can be capable of four-wheel steering. For example: (1) the set of wheels can further include a rear left wheel of the vehicle and a rear right wheel of the vehicle, (2) the set of steering actuators can further include a third steering actuator and a fourth steering actuator, and (3) the set of steering angles can further include a third steering angle and a fourth steering angle. For example, the third steering actuator can be for the rear left wheel and the fourth steering actuator can be for the rear right wheel. For example, the third steering angle can be for the rear left wheel and the fourth steering angle can be for the rear right wheel. For example, the third steering actuator and the fourth steering actuator can be configured so that the third steering angle and the fourth steering angle comply with Ackermann steering geometry. Alternatively, for example, the third steering angle, controlled by the third steering actuator, can be independent of the fourth steering angle controlled by the fourth steering actuator. For example, the first steering angle, the second steering angle, the third steering angle, and the fourth steering angle can be configured so that: (1) a difference between: (a) a lateral acceleration of the vehicle on the actual path and (b) a lateral acceleration of the vehicle on the simulated path can be: (1) less than: (a) a threshold lateral acceleration greater than (b) a lateral acceleration of the vehicle in a situation in which: (i) the simulated path is the actual path, but (ii) the third steering angle is zero degrees and the fourth steering angle is zero degrees (e.g., a two-wheel steering situation). For example, studies have demonstrated that the occupant of the vehicle will not perceive the difference if the difference is less than the threshold lateral acceleration greater than the lateral acceleration of the vehicle in the situation in which the simulated path is the actual path and the vehicle is using two-wheel steering.

In FIG. 7B, in the method 700, additionally, at an operation 708, for example, the steering module 606 can produce, based on the first signal, a third signal. For example, the third signal can be configured to cause a steering torque actuator for the steering operator interface to produce, in response to the position of the steering operator interface being associated with causing the vehicle to move along the simulated path, a steering torque having a measurement associated with causing the vehicle to move along the simulated path rather than a measurement associated with causing the vehicle to move along the actual path. For example, the steering torque actuator can be a component of the steer-by-wire system.

At an operation 710, for example, the first communications module 608 can transmit the third signal to the steering torque actuator.

Additionally, at an operation 712, for example, the first communications module 608 can transmit the first signal to the audiovisual module 614.

At an operation 714, for example, the audiovisual module 614 can produce, based on the first signal, a fourth signal. For example, the fourth signal can be configured to cause one or more of a display screen or a speaker to produce one or more of a visual representation or an audio representation of objects encountered along the simulated path. For example, the one or more of the visual representation or the audio representation can include a virtual reality (VR) representation. In a first variation of a first example: (1) the vehicle can include a wireless communications device and (2) a VR headset can include a wireless communications device, the second processor 610, the second memory 612, and the one or more of the display screen or the speaker. For example, the occupant can wear the VR headset. For example, the wireless communications device included in the vehicle can be communicably coupled to the first processor 602 and the wireless communications device included in the VR headset can be communicably coupled to the second processor 610. For example, at the operation 712, the first communications module 608 can transmit, via the wireless communications device included in the vehicle and the wireless communications device included in the VR headset, the first signal to the audiovisual module 614. In a second variation of the first example, a cable can be connected to the first processor 602 and can be configured to be connected to the second processor 610 included in the VR headset. For example, at the operation 712, the first communications module 608 can transmit, via the cable, the first signal to the audiovisual module 614. In a second example, the vehicle 502 can include a second ECU and the one or more of the display screen or the speaker. For example, the second ECU can house the second processor 610 and the second memory 612. For example: (1) the display screen can include a set of display screens, (2) the vehicle can include a set of windows, and (3) each window, of the set of windows, can be covered by a corresponding display screen of the set of display screens.

At an operation 716, for example, the second communications module 616 can transmit the fourth signal to the one or more of the display screen or the speaker.

In FIG. 7C, in the method 700, additionally, at an operation 718, for example, the third communications module 622 can receive a fifth signal indicative of a position of an accelerating operator interface. For example, a position sensor for the accelerating operator interface can be configured to produce the fifth signal and to transmit the fifth signal to the third communications module 622.

At an operation 720, for example, the third communications module 622 can transmit a sixth signal to an acceleration control device.

At an operation 722, for example, the acceleration module 624 can produce, based on the fifth signal, the sixth signal. For example, the sixth signal can be configured to control the acceleration control device to cause, in response to the position of the accelerating operator interface being associated with causing the vehicle to move at a first rate of acceleration, the vehicle to move at a second rate of acceleration.

For example, because the actual path of the vehicle can include one or more of sharper curves or sharper turns than the simulated path of the vehicle, the second rate of acceleration can be slower than the first rate of acceleration so that the occupant of the vehicle can be less likely to perceive lateral accelerations associated with the actual path being different from the simulated path. Additionally, for example, one or more operations of the method 700 may occur for a duration of time greater than a duration threshold so that the occupant can perceive the simulated reality to be the actual reality. For example, the duration threshold can be about thirty minutes. During this duration of time, for example, the simulated reality can become familiar to the occupant so that the simulated reality no longer seems unusual and can be accepted as normal. During this duration of time, for example, a speed of the vehicle can be gradually reduced so that subsequent changes in speed can include a slower range of speeds so that, again, the occupant of the vehicle can be less likely to perceive lateral accelerations associated with the actual path being different from the simulated path.

For example, the third processor 618 can be housed in a third ECU. For example, the third ECU can be configured to operate a drive-by-wire system. For example, the accelerating operator interface can include an accelerator pedal, a joystick-like control lever, or the like. For example, the acceleration control device can include one or more of a control device configured to control a position of a throttle for an internal combustion engine or a motor controller configured to control an amount of current conveyed from an electric vehicle battery.

Additionally, at an operation 724, for example, the fourth communications module 630 can receive a seventh signal indicative of a position of a braking operator interface. For example, a position sensor for the braking operator interface can be configured to produce the seventh signal and to transmit the seventh signal to the fourth communications module 630.

At an operation 726, for example, the fourth communications module 630 can transmit an eighth signal to one or more of the braking actuators for one or more brakes.

At an operation 728, for example, the deceleration module 632 can produce, based on the seventh signal, the eighth signal. For example, the eighth signal can be configured to cause the one or more braking actuators to cause, in response to the position of the braking operator interface being associated with causing the vehicle to move at a first rate of deceleration, the vehicle to move at a second rate of deceleration.

For example, because the actual path of the vehicle can include one or more of sharper curves or sharper turns than the simulated path of the vehicle, the second rate of deceleration can be slower than the first rate of deceleration so that the occupant of the vehicle can be less likely to perceive lateral accelerations associated with the actual path being different from the simulated path. Additionally, for example, one or more operations of the method 700 may occur for a duration of time greater than a duration threshold so that the occupant can perceive the simulated reality to be the actual reality. For example, the duration threshold can be about thirty minutes. During this duration of time, for example, the simulated reality can become familiar to the occupant so that the simulated reality no longer seems unusual and can be accepted as normal. During this duration of time, for example, a speed of the vehicle can be gradually reduced so that subsequent changes in speed can include a slower range of speeds so that, again, the occupant of the vehicle can be less likely to perceive lateral accelerations associated with the actual path being different from the simulated path.

For example, the fourth processor 626 can be housed in a fourth ECU. For example, the fourth ECU can be configured to operate a brake-by-wire system. For example, the decelerating operator interface can include a brake pedal, a joystick-like control lever, or the like.

In FIG. 7A, in the method 700, additionally, at an operation 730, for example, one or more of the first communications module 608, the second communications module 616, the third communications module 622, or the fourth communications module 630 can receive a ninth signal configured to initiate operations of the method 700. In a first example, a user interface can be configured to produce the ninth signal and to transmit the ninth signal to the one or more of the first communications module 608, the second communications module 616, the third communications module 622, or the fourth communications module 630. In a second example, a server can be configured to produce the ninth signal and to transmit, via a wireless communications device included in the vehicle, the ninth signal to the one or more of the first communications module 608, the second communications module 616, the third communications module 622, or the fourth communications module 630.

For example, in an implementation, the simulated path can include a straight path and the actual path can include a circular path. Accordingly, additionally, at an operation 732, for example, the first communications module 608 can receive a tenth signal indicative of a measurement of a radius of the circular path. For example, at the operation 704, the steering module 606 can produce, based on the first signal (the position of the steering operator interface) and the tenth signal (the measurement of the radius of the circular path), the second signal (configured to cause the steering actuator to produce the steering angle for the actual path). In a first example, a user interface can be configured to produce the tenth signal and to transmit the tenth signal to the first communications module 608. In a second example, a server can be configured to produce the tenth signal and to transmit, via a wireless communications device included in the vehicle, the tenth signal to the first communications module 608.

For example: (1) the straight path can include a set of parallel lanes, (2) the circular path can include a set of concentric circular lanes, and (3) each circular lane, of the set of concentric circular lanes, can be associated with a corresponding lane of the set of parallel lanes.

For example, the simulated path, in response to changes of the position of the steering operator interface, can further include a change from a first lane, of the set of parallel lanes, to a second lane of the set of parallel lanes. Accordingly, additionally, at an operation 734, the radius determination module 634 can determine, based on the tenth signal, a measurement of a distance between the first lane and the second lane, and a direction of an initial change of the changes of the position of the steering operator interface, a measurement of a radius of a circular lane associated with the second lane. For example, at the operation 704, the steering module 606 can produce, based on the first signal (the position of the steering operator interface) and one or more of the tenth signal (the measurement of the radius of the circular path) or the measurement of the radius of the circular lane associated with the second lane, the second signal (configured to cause the steering actuator to produce the steering angle for the actual path).

For example, in an implementation: (1) the simulated path can include one or more simulated turns at a first specific angle (e.g., 90 degrees), (2) the actual path can include one or more actual turns at a second specific angle (e.g., 180 degrees), and (3) an actual turn, included in the actual path, can be associated with a corresponding simulated turn included in the simulated path.

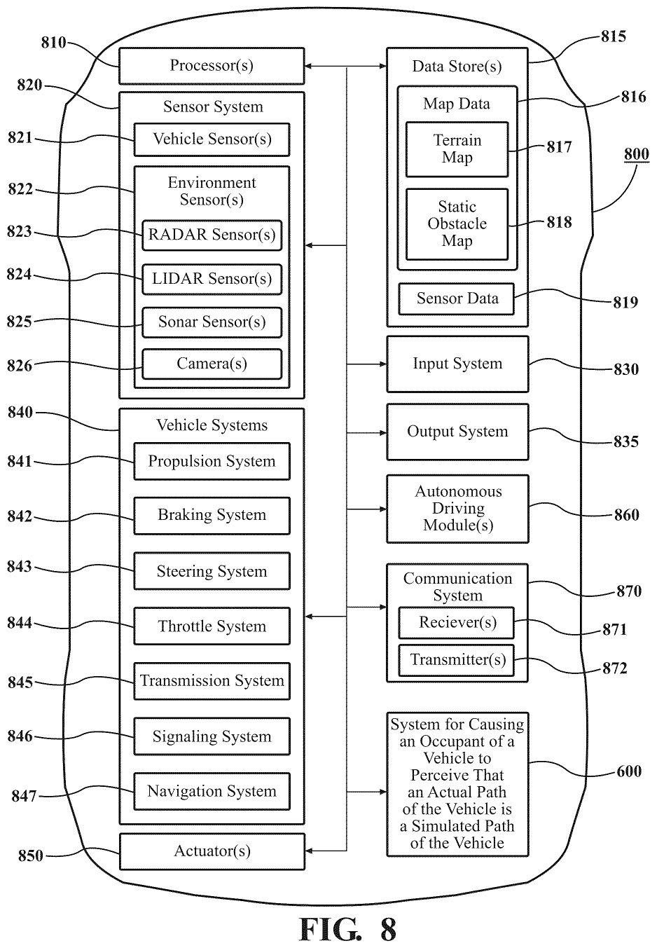

FIG. 8 includes a block diagram that illustrates an example of elements disposed on a vehicle 800, according to the disclosed technologies. As used herein, a “vehicle” can be any form of powered transport. In one or more implementations, the vehicle 800 can be an automobile. While arrangements described herein are with respect to automobiles, one of skill in the art understands, in light of the description herein, that embodiments are not limited to automobiles. For example, functions and/or operations of one or more of the vehicle 106 (illustrated in FIGS. 1-4) or the vehicle 502 (illustrated in FIG. 5) can be realized by the vehicle 800.

In some embodiments, the vehicle 800 can be configured to switch selectively between an automated mode, one or more semi-automated operational modes, and/or a manual mode. Such switching can be implemented in a suitable manner, now known or later developed. As used herein, “manual mode” can refer that all of or a majority of the navigation and/or maneuvering of the vehicle 800 is performed according to inputs received from a user (e.g., human driver). In one or more arrangements, the vehicle 800 can be a conventional vehicle that is configured to operate in only a manual mode.

In one or more embodiments, the vehicle 800 can be an automated vehicle. As used herein, “automated vehicle” can refer to a vehicle that operates in an automated mode. As used herein, “automated mode” can refer to navigating and/or maneuvering the vehicle 800 along a travel route using one or more computing systems to control the vehicle 800 with minimal or no input from a human driver. In one or more embodiments, the vehicle 800 can be highly automated or completely automated. In one embodiment, the vehicle 800 can be configured with one or more semi-automated operational modes in which one or more computing systems perform a portion of the navigation and/or maneuvering of the vehicle along a travel route, and a vehicle operator (i.e., driver) provides inputs to the vehicle 800 to perform a portion of the navigation and/or maneuvering of the vehicle 800 along a travel route.

For example, Standard J3016 202104, Taxonomy and Definitions for Terms Related to Driving Automation Systems for On-Road Motor Vehicles, issued by the Society of Automotive Engineers (SAE) International on Jan. 16, 2014, and most recently revised on Apr. 30, 2021, defines six levels of driving automation. These six levels include: (1) level 0, no automation, in which all aspects of dynamic driving tasks are performed by a human driver; (2) level 1, driver assistance, in which a driver assistance system, if selected, can execute, using information about the driving environment, either steering or acceleration/deceleration tasks, but all remaining driving dynamic tasks are performed by a human driver; (3) level 2, partial automation, in which one or more driver assistance systems, if selected, can execute, using information about the driving environment, both steering and acceleration/deceleration tasks, but all remaining driving dynamic tasks are performed by a human driver; (4) level 3, conditional automation, in which an automated driving system, if selected, can execute all aspects of dynamic driving tasks with an expectation that a human driver will respond appropriately to a request to intervene; (5) level 4, high automation, in which an automated driving system, if selected, can execute all aspects of dynamic driving tasks even if a human driver does not respond appropriately to a request to intervene; and (6) level 5, full automation, in which an automated driving system can execute all aspects of dynamic driving tasks under all roadway and environmental conditions that can be managed by a human driver.

The vehicle 800 can include various elements. The vehicle 800 can have any combination of the various elements illustrated in FIG. 8. In various embodiments, it may not be necessary for the vehicle 800 to include all of the elements illustrated in FIG. 8. Furthermore, the vehicle 800 can have elements in addition to those illustrated in FIG. 8. While the various elements are illustrated in FIG. 8 as being located within the vehicle 800, one or more of these elements can be located external to the vehicle 800. Furthermore, the elements illustrated may be physically separated by large distances. For example, as described, one or more components of the disclosed system can be implemented within the vehicle 800 while other components of the system can be implemented within a cloud-computing environment, as described below. For example, the elements can include one or more processors 810, one or more data stores 815, a sensor system 820, an input system 830, an output system 835, vehicle systems 840, one or more actuators 850, one or more automated driving modules 860, a communications system 870, and the system 600 for causing an occupant of a vehicle to perceive that an actual path of the vehicle is a simulated path of the vehicle.

In one or more arrangements, the one or more processors 810 can be a main processor of the vehicle 800. For example, the one or more processors 810 can be an electronic control unit (ECU). For example, functions and/or operations of one or more of the processor 516 (illustrated in FIG. 5), the processor 520 (illustrated in FIG. 5), the processor 541 (illustrated in FIG. 5), the processor 556 (illustrated in FIG. 5), the first processor 602 (illustrated in FIG. 6), the second processor 610 (illustrated in FIG. 6), the third processor 618 (illustrated in FIG. 6), or the fourth processor 626 (illustrated in FIG. 6) can be realized by the one or more processors 810.

The one or more data stores 815 can store, for example, one or more types of data. The one or more data stores 815 can include volatile memory and/or non-volatile memory. Examples of suitable memory for the one or more data stores 815 can include Random-Access Memory (RAM), flash memory, Read-Only Memory (ROM), Programmable Read-Only Memory (PROM), Erasable Programmable Read-Only Memory (EPROM), Electrically Erasable Programmable Read-Only Memory (EEPROM), registers, magnetic disks, optical disks, hard drives, any other suitable storage medium, or any combination thereof. The one or more data stores 815 can be a component of the one or more processors 810. Additionally or alternatively, the one or more data stores 815 can be operatively connected to the one or more processors 810 for use thereby. As used herein, “operatively connected” can include direct or indirect connections, including connections without direct physical contact. As used herein, a statement that a component can be “configured to” perform an operation can be understood to mean that the component requires no structural alterations, but merely needs to be placed into an operational state (e.g., be provided with electrical power, have an underlying operating system running, etc.) in order to perform the operation. For example, functions and/or operations of one or more of the memory 517 (illustrated in FIG. 5), the memory 521 (illustrated in FIG. 5), the memory 542 (illustrated in FIG. 5), the memory 557 (illustrated in FIG. 5), the first memory 604 (illustrated in FIG. 6), the second memory 612 (illustrated in FIG. 6), the third memory 620 (illustrated in FIG. 6), or the fourth memory 628 (illustrated in FIG. 6) can be realized by the one or more data stores 815.

In one or more arrangements, the one or more data stores 815 can store map data 816. The map data 816 can include maps of one or more geographic areas. In some instances, the map data 816 can include information or data on roads, traffic control devices, road markings, structures, features, and/or landmarks in the one or more geographic areas. The map data 816 can be in any suitable form. In some instances, the map data 816 can include aerial views of an area. In some instances, the map data 816 can include ground views of an area, including 360-degree ground views. The map data 816 can include measurements, dimensions, distances, and/or information for one or more items included in the map data 816 and/or relative to other items included in the map data 816. The map data 816 can include a digital map with information about road geometry. The map data 816 can be high quality and/or highly detailed.

In one or more arrangements, the map data 816 can include one or more terrain maps 817. The one or more terrain maps 817 can include information about the ground, terrain, roads, surfaces, and/or other features of one or more geographic areas. The one or more terrain maps 817 can include elevation data of the one or more geographic areas. The map data 816 can be high quality and/or highly detailed. The one or more terrain maps 817 can define one or more ground surfaces, which can include paved roads, unpaved roads, land, and other things that define a ground surface.

In one or more arrangements, the map data 816 can include one or more static obstacle maps 818. The one or more static obstacle maps 818 can include information about one or more static obstacles located within one or more geographic areas. A “static obstacle” can be a physical object whose position does not change (or does not substantially change) over a period of time and/or whose size does not change (or does not substantially change) over a period of time. Examples of static obstacles can include trees, buildings, curbs, fences, railings, medians, utility poles, statues, monuments, signs, benches, furniture, mailboxes, large rocks, and hills. The static obstacles can be objects that extend above ground level. The one or more static obstacles included in the one or more static obstacle maps 818 can have location data, size data, dimension data, material data, and/or other data associated with them. The one or more static obstacle maps 818 can include measurements, dimensions, distances, and/or information for one or more static obstacles. The one or more static obstacle maps 818 can be high quality and/or highly detailed. The one or more static obstacle maps 818 can be updated to reflect changes within a mapped area.

In one or more arrangements, the one or more data stores 815 can store sensor data 819. As used herein, “sensor data” can refer to any information about the sensors with which the vehicle 800 can be equipped including the capabilities of and other information about such sensors. The sensor data 819 can relate to one or more sensors of the sensor system 820. For example, in one or more arrangements, the sensor data 819 can include information about one or more lidar sensors 824 of the sensor system 820.

In some arrangements, at least a portion of the map data 816 and/or the sensor data 819 can be located in one or more data stores 815 that are located onboard the vehicle 800. Additionally or alternatively, at least a portion of the map data 816 and/or the sensor data 819 can be located in one or more data stores 815 that are located remotely from the vehicle 800.

The sensor system 820 can include one or more sensors. As used herein, a “sensor” can refer to any device, component, and/or system that can detect and/or sense something. The one or more sensors can be configured to detect and/or sense in real-time. As used herein, the term “real-time” can refer to a level of processing responsiveness that is perceived by a user or system to be sufficiently immediate for a particular process or determination to be made, or that enables the processor to keep pace with some external process.

In arrangements in which the sensor system 820 includes a plurality of sensors, the sensors can work independently from each other. Alternatively, two or more of the sensors can work in combination with each other. In such a case, the two or more sensors can form a sensor network. The sensor system 820 and/or the one or more sensors can be operatively connected to the one or more processors 810, the one or more data stores 815, and/or another element of the vehicle 800 (including any of the elements illustrated in FIG. 8). The sensor system 820 can acquire data of at least a portion of the external environment of the vehicle 800 (e.g., nearby vehicles). The sensor system 820 can include any suitable type of sensor. Various examples of different types of sensors are described herein. However, one of skill in the art understands that the embodiments are not limited to the particular sensors described herein.

The sensor system 820 can include one or more vehicle sensors 821. The one or more vehicle sensors 821 can detect, determine, and/or sense information about the vehicle 800 itself. In one or more arrangements, the one or more vehicle sensors 821 can be configured to detect and/or sense position and orientation changes of the vehicle 800 such as, for example, based on inertial acceleration. In one or more arrangements, the one or more vehicle sensors 821 can include one or more accelerometers, one or more gyroscopes, an inertial measurement unit (IMU), a dead-reckoning system, a global navigation satellite system (GNSS), a global positioning system (GPS), a navigation system 847, and/or other suitable sensors. The one or more vehicle sensors 821 can be configured to detect and/or sense one or more characteristics of the vehicle 800. In one or more arrangements, the one or more vehicle sensors 821 can include a speedometer to determine a current speed of the vehicle 800. For example, functions and/or operations of one or more of the position sensor 518 (illustrated in FIG. 5), the position sensor 543 (illustrated in FIG. 5), or the position sensor 558 (illustrated in FIG. 5) can be realized by the one or more vehicle sensors 821.

Additionally or alternatively, the sensor system 820 can include one or more environment sensors 822 configured to acquire and/or sense driving environment data. As used herein, “driving environment data” can include data or information about the external environment in which a vehicle is located or one or more portions thereof. For example, the one or more environment sensors 822 can be configured to detect, quantify, and/or sense obstacles in at least a portion of the external environment of the vehicle 800 and/or information/data about such obstacles. Such obstacles may be stationary objects and/or dynamic objects. The one or more environment sensors 822 can be configured to detect, measure, quantify, and/or sense other things in the external environment of the vehicle 800 such as, for example, lane markers, signs, traffic lights, traffic signs, lane lines, crosswalks, curbs proximate the vehicle 800, off-road objects, etc. For example, functions and/or operations of the environment sensor 561 (illustrated in FIG. 5) can be realized by the one or more environment sensors 822.

Various examples of sensors of the sensor system 820 are described herein. The example sensors may be part of the one or more vehicle sensors 821 and/or the one or more environment sensors 822. However, one of skill in the art understands that the embodiments are not limited to the particular sensors described.

In one or more arrangements, the one or more environment sensors 822 can include one or more radar sensors 823, one or more lidar sensors 824, one or more sonar sensors 825, and/or one more cameras 826. In one or more arrangements, the one or more cameras 826 can be one or more high dynamic range (HDR) cameras or one or more infrared (IR) cameras. For example, the one or more cameras 826 can be used to record a reality of a state of an item of information that can appear in the digital map.

The input system 830 can include any device, component, system, element, arrangement, or groups thereof that enable information/data to be entered into a machine. The input system 830 can receive an input from a vehicle passenger (e.g., a driver or a passenger). For example, functions and/or operations of the user interface 559 (illustrated in FIG. 5) can be realized by the input system 830. The output system 835 can include any device, component, system, element, arrangement, or groups thereof that enable information/data to be presented to a vehicle passenger (e.g., a driver or a passenger). For example, functions and/or operations of one or more of the display screen 522 (illustrated in FIG. 5) or the speaker 523 (illustrated in FIG. 5) can be realized by the output system 835.

Various examples of the one or more vehicle systems 840 are illustrated in FIG. 8. However, one of skill in the art understands that the vehicle 800 can include more, fewer, or different vehicle systems. Although particular vehicle systems can be separately defined, each or any of the systems or portions thereof may be otherwise combined or segregated via hardware and/or software within the vehicle 800. For example, the one or more vehicle systems 840 can include a propulsion system 841, a braking system 842, a steering system 843, a throttle system 844, a transmission system 845, a signaling system 846, and/or the navigation system 847. Each of these systems can include one or more devices, components, and/or a combination thereof, now known or later developed. For example, functions and/or operations of one or more of the internal combustion engine 532 (illustrated in FIG. 5) or the electric vehicle battery 533 (illustrated in FIG. 5) can be realized by the propulsion system 841. For example, functions and/or operations of one or more of the brake 544 (illustrated in FIG. 5), the brake 545 (illustrated in FIG. 5), the brake 546 (illustrated in FIG. 5), the brake 547 (illustrated in FIG. 5), or the braking operator interface 552 (illustrated in FIG. 5) can be realized by the braking system 842. For example, functions and/or operations of the steering operator interface 511 (illustrated in FIG. 5) can be realized by the steering system 843. For example, functions and/or operations of one or more of the acceleration control device 531 (illustrated in FIG. 5) or the accelerating operator interface 537 (illustrated in FIG. 5) can be realized by the throttle system 844.

The navigation system 847 can include one or more devices, applications, and/or combinations thereof, now known or later developed, configured to determine the geographic location of the vehicle 800 and/or to determine a travel route for the vehicle 800. The navigation system 847 can include one or more mapping applications to determine a travel route for the vehicle 800. The navigation system 847 can include a global positioning system, a local positioning system, a geolocation system, and/or a combination thereof.

The one or more actuators 850 can be any element or combination of elements operable to modify, adjust, and/or alter one or more of the vehicle systems 840 or components thereof responsive to receiving signals or other inputs from the one or more processors 810 and/or the one or more automated driving modules 860. Any suitable actuator can be used. For example, the one or more actuators 850 can include motors, pneumatic actuators, hydraulic pistons, relays, solenoids, and/or piezoelectric actuators. For example, functions and/or operations of one or more of steering actuator 507 (illustrated in FIG. 5), the steering actuator 508 (illustrated in FIG. 5), the steering actuator 509 (illustrated in FIG. 5), the steering actuator 510 (illustrated in FIG. 5), the steering torque actuator 519 (illustrated in FIG. 5), the braking actuator 548 (illustrated in FIG. 5), the braking actuator 549 (illustrated in FIG. 5), the braking actuator 550 (illustrated in FIG. 5), or the braking actuator 551 (illustrated in FIG. 5) can be realized by the one or more actuators 850.

The one or more processors 810 and/or the one or more automated driving modules 860 can be operatively connected to communicate with the various vehicle systems 840 and/or individual components thereof. For example, the one or more processors 810 and/or the one or more automated driving modules 860 can be in communication to send and/or receive information from the various vehicle systems 840 to control the movement, speed, maneuvering, heading, direction, etc. of the vehicle 800. The one or more processors 810 and/or the one or more automated driving modules 860 may control some or all of these vehicle systems 840 and, thus, may be partially or fully automated.

The one or more processors 810 and/or the one or more automated driving modules 860 may be operable to control the navigation and/or maneuvering of the vehicle 800 by controlling one or more of the vehicle systems 840 and/or components thereof. For example, when operating in an automated mode, the one or more processors 810 and/or the one or more automated driving modules 860 can control the direction and/or speed of the vehicle 800. The one or more processors 810 and/or the one or more automated driving modules 860 can cause the vehicle 800 to accelerate (e.g., by increasing the supply of fuel provided to the engine), decelerate (e.g., by decreasing the supply of fuel to the engine and/or by applying brakes) and/or change direction (e.g., by turning the front two wheels). As used herein, “cause” or “causing” can mean to make, force, compel, direct, command, instruct, and/or enable an event or action to occur or at least be in a state where such event or action may occur, either in a direct or indirect manner.

The communications system 870 can include one or more receivers 871 and/or one or more transmitters 872. The communications system 870 can receive and transmit one or more messages through one or more wireless communications channels. For example, the one or more wireless communications channels can be in accordance with the Institute of Electrical and Electronics Engineers (IEEE) 802.11p standard to add wireless access in vehicular environments (WAVE) (the basis for Dedicated Short-Range Communications (DSRC)), the 3rd Generation Partnership Project (3GPP) Long-Term Evolution (LTE) Vehicle-to-Everything (V2X) (LTE-V2X) standard (including the LTE Uu interface between a mobile communication device and an Evolved Node B of the Universal Mobile Telecommunications System), the 3GPP fifth generation (5G) New Radio (NR) Vehicle-to-Everything (V2X) standard (including the 5G NR Uu interface), or the like. For example, the communications system 870 can include “connected vehicle” technology. “Connected vehicle” technology can include, for example, devices to exchange communications between a vehicle and other devices in a packet-switched network. Such other devices can include, for example, another vehicle (e.g., “Vehicle to Vehicle” (V2V) technology), roadside infrastructure (e.g., “Vehicle to Infrastructure” (V2I) technology), a cloud platform (e.g., “Vehicle to Cloud” (V2C) technology), a pedestrian (e.g., “Vehicle to Pedestrian” (V2P) technology), or a network (e.g., “Vehicle to Network” (V2N) technology. “Vehicle to Everything” (V2X) technology can integrate aspects of these individual communications technologies. For example, functions and/or operations of the wireless communications device 525 (illustrated in FIG. 5) can be realized by the communications system 870.

Moreover, the one or more processors 810, the one or more data stores 815, and the communications system 870 can be configured to one or more of form a micro cloud, participate as a member of a micro cloud, or perform a function of a leader of a micro cloud. A micro cloud can be characterized by a distribution, among members of the micro cloud, of one or more of one or more computing resources or one or more data storage resources in order to collaborate on executing operations. The members can include at least connected vehicles.

The vehicle 800 can include one or more modules, at least some of which are described herein. The modules can be implemented as computer-readable program code that, when executed by the one or more processors 810, implement one or more of the various processes described herein. One or more of the modules can be a component of the one or more processors 810. Additionally or alternatively, one or more of the modules can be executed on and/or distributed among other processing systems to which the one or more processors 810 can be operatively connected. The modules can include instructions (e.g., program logic) executable by the one or more processors 810. Additionally or alternatively, the one or more data store 815 may contain such instructions.

In one or more arrangements, one or more of the modules described herein can include artificial or computational intelligence elements, e.g., neural network, fuzzy logic, or other machine learning algorithms. Further, in one or more arrangements, one or more of the modules can be distributed among a plurality of the modules described herein. In one or more arrangements, two or more of the modules described herein can be combined into a single module.

The vehicle 800 can include one or more automated driving modules 860. The one or more automated driving modules 860 can be configured to receive data from the sensor system 820 and/or any other type of system capable of capturing information relating to the vehicle 800 and/or the external environment of the vehicle 800. In one or more arrangements, the one or more automated driving modules 860 can use such data to generate one or more driving scene models. The one or more automated driving modules 860 can determine position and velocity of the vehicle 800. The one or more automated driving modules 860 can determine the location of obstacles, obstacles, or other environmental features including traffic signs, trees, shrubs, neighboring vehicles, pedestrians, etc.

The one or more automated driving modules 860 can be configured to receive and/or determine location information for obstacles within the external environment of the vehicle 800 for use by the one or more processors 810 and/or one or more of the modules described herein to estimate position and orientation of the vehicle 800, vehicle position in global coordinates based on signals from a plurality of satellites, or any other data and/or signals that could be used to determine the current state of the vehicle 800 or determine the position of the vehicle 800 with respect to its environment for use in either creating a map or determining the position of the vehicle 800 in respect to map data.

The one or more automated driving modules 860 can be configured to determine one or more travel paths, current automated driving maneuvers for the vehicle 800, future automated driving maneuvers and/or modifications to current automated driving maneuvers based on data acquired by the sensor system 820, driving scene models, and/or data from any other suitable source such as determinations from the sensor data 819. As used herein, “driving maneuver” can refer to one or more actions that affect the movement of a vehicle. Examples of driving maneuvers include: accelerating, decelerating, braking, turning, moving in a lateral direction of the vehicle 800, changing travel lanes, merging into a travel lane, and/or reversing, just to name a few possibilities. The one or more automated driving modules 860 can be configured to implement determined driving maneuvers. The one or more automated driving modules 860 can cause, directly or indirectly, such automated driving maneuvers to be implemented. As used herein, “cause” or “causing” means to make, command, instruct, and/or enable an event or action to occur or at least be in a state where such event or action may occur, either in a direct or indirect manner. The one or more automated driving modules 860 can be configured to execute various vehicle functions and/or to transmit data to, receive data from, interact with, and/or control the vehicle 800 or one or more systems thereof (e.g., one or more of vehicle systems 840). For example, functions and/or operations of an automotive navigation system can be realized by the one or more automated driving modules 860.

Detailed embodiments are disclosed herein. However, one of skill in the art understands, in light of the description herein, that the disclosed embodiments are intended only as examples. Therefore, specific structural and functional details disclosed herein are not to be interpreted as limiting, but merely as a basis for the claims and as a representative basis for teaching one of skill in the art to variously employ the aspects herein in virtually any appropriately detailed structure. Furthermore, the terms and phrases used herein are not intended to be limiting but rather to provide an understandable description of possible implementations. Various embodiments are illustrated in FIGS. 1-6, 7A-7C, and 8, but the embodiments are not limited to the illustrated structure or application.

The flowchart and block diagrams in the figures illustrate the architecture, functionality, and operation of possible implementations of systems, methods, and computer program products according to various embodiments. In this regard, each block in flowcharts or block diagrams may represent a module, segment, or portion of code, which comprises one or more executable instructions for implementing the specified logical function(s). One of skill in the art understands, in light of the description herein, that, in some alternative implementations, the functions described in a block may occur out of the order depicted by the figures. For example, two blocks depicted in succession may, in fact, be executed substantially concurrently, or the blocks may be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suitable. A typical combination of hardware and software can be a processing system with computer-readable program code that, when loaded and executed, controls the processing system such that it carries out the methods described herein. The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product that comprises all the features enabling the implementation of the methods described herein and that, when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. As used herein, the phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples of the computer-readable storage medium would include, in a non-exhaustive list, the following: a portable computer diskette, a hard disk drive (HDD), a solid-state drive (SSD), a read-only memory (ROM), an erasable programmable read-only memory (EPROM or flash memory), a portable compact disc read-only memory (CD-ROM), a digital versatile disc (DVD), an optical storage device, a magnetic storage device, or any suitable combination of the foregoing. As used herein, a computer-readable storage medium may be any tangible medium that can contain or store a program for use by or in connection with an instruction execution system, apparatus, or device.

Generally, modules, as used herein, include routines, programs, objects, components, data structures, and so on that perform particular tasks or implement particular data types. In further aspects, a memory generally stores such modules. The memory associated with a module may be a buffer or may be cache embedded within a processor, a random-access memory (RAM), a ROM, a flash memory, or another suitable electronic storage medium. In still further aspects, a module as used herein, may be implemented as an application-specific integrated circuit (ASIC), a hardware component of a system on a chip (SoC), a programmable logic array (PLA), or another suitable hardware component (e.g., a central processing unit (CPU), a graphics processing unit (GPU), a field-programmable gate array (FPGA), or the like) that is embedded with a defined configuration set (e.g., instructions) for performing the disclosed functions.

Program code embodied on a computer-readable medium may be transmitted using any appropriate medium, including but not limited to wireless, wireline, optical fiber, cable, radio frequency (RF), etc., or any suitable combination of the foregoing. Computer program code for carrying out operations for aspects of the disclosed technologies may be written in any combination of one or more programming languages, including an object-oriented programming language such as Java™, Smalltalk, C++, or the like, and conventional procedural programming languages such as the “C” programming language or similar programming languages. The program code may execute entirely on a user's computer, partly on a user's computer, as a stand-alone software package, partly on a user's computer and partly on a remote computer, or entirely on a remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . or . . . ” as used herein refers to and encompasses any and all possible combinations of one or more of the associated listed items. For example, the phrase “at least one of A, B, or C” includes A only, B only, C only, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

1. A system, comprising:
a first processor; and
a first memory storing:
a steering module including instructions that cause the first processor to:
receive a first signal indicative of a position of a steering operator interface; and
produce, based on the first signal, a second signal configured to cause a steering actuator for a wheel to produce, in response to the position of the steering operator interface being associated with causing a vehicle to move along a simulated path, a steering angle for an actual path along which the vehicle is intended to move; and
a first communications module including instructions that cause the processor to transmit the second signal to the steering actuator to produce the steering angle to cause the vehicle to move along the actual path in a manner such that an occupant of the vehicle perceives that the vehicle is moving along the simulated path.

2. The system of claim 1, wherein the steering operator interface comprises a steering wheel, a yoke, a handlebar, a twin lever steering interface, or a joystick-like control lever.

3. The system of claim 1, wherein:
the wheel comprises a set of wheels,
the steering angle comprises a set of steering angles,
the steering actuator comprises a set of steering actuators, and
each wheel, of the set of wheels, is associated with a corresponding steering actuator of the set of steering actuators.

4. The system of claim 3, wherein:
the set of wheels comprises a front left wheel of the vehicle and a front right wheel of the vehicle,
the set of steering actuators comprises a first steering actuator and a second steering actuator, the first steering actuator being for the front left wheel, and the second steering actuator being for the front right wheel, and
the set of steering angles comprises a first steering angle and a second steering angle, the first steering angle being for the front left wheel, and the second steering angle being for the front right wheel.

5. The system of claim 4, wherein the first steering angle, controlled by the first steering actuator, is independent of the second steering angle controlled by the second steering actuator.

6. The system of claim 4, wherein:
the set of wheels further comprises a rear left wheel of the vehicle and a rear right wheel of the vehicle,
the set of steering actuators further comprises a third steering actuator and a fourth steering actuator, the third steering actuator being for the rear left wheel, and the fourth steering actuator being for the rear right wheel, and
the set of steering angles further comprises a third steering angle and a fourth steering angle, the third steering angle being for the rear left wheel, and the fourth steering angle being for the rear right wheel.

7. The system of claim 6, wherein the third steering angle, controlled by the third steering actuator, is independent of the fourth steering angle controlled by the fourth steering actuator.

8. The system of claim 6, wherein the first steering angle, the second steering angle, the third steering angle, and the fourth steering angle are configured so that a difference between a lateral acceleration of the vehicle on the actual path and a lateral acceleration of the vehicle on the simulated path is less than a threshold lateral acceleration greater than a lateral acceleration of the vehicle in a situation in which the simulated path is the actual path, but the third steering angle is zero degrees and the fourth steering angle is zero degrees.

9. The system of claim 1, wherein:
the steering module further includes instructions to produce, based on the first signal, a third signal configured to cause a steering torque actuator for the steering operator interface to produce, in response to the position of the steering operator interface being associated with causing the vehicle to move along the simulated path, a steering torque having a measurement associated with causing the vehicle to move along the simulated path rather than a measurement associated with causing the vehicle to move along the actual path, and
the first communications module further includes instructions to transmit the third signal to the steering torque actuator.

10. The system of claim 1:
wherein the first communications module further includes instructions to transmit the first signal to a second processor;
further comprising:
the second processor; and
a second memory storing:
an audiovisual module including instructions that cause the second processor to produce, based on the first signal, a third signal configured to cause at least one of a display screen or a speaker to produce at least one of a visual representation or an audio representation of objects encountered along the simulated path; and
a second communications module including instructions that cause the second processor to transmit the third signal to the at least one of the display screen or the speaker.

11. The system of claim 1, further comprising:
a second processor; and
a second memory storing:
a second communications module including instructions that cause the second processor to:
receive a third signal indicative of a position of an accelerating operator interface; and
transmit a fourth signal to an acceleration control device; and
an acceleration module including instructions that cause the second processor to produce, based on the third signal, the fourth signal configured to control the acceleration control device to cause, in response to the position of the accelerating operator interface being associated with causing the vehicle to move at a first rate of acceleration, the vehicle to move at a second rate of acceleration.

12. The system of claim 1, further comprising:
a second processor; and
a second memory storing:
a second communications module including instructions that cause the second processor to:
receive a third signal indicative of a position of a braking operator interface; and
transmit a fourth signal to at least one braking actuator for at least one brake; and
a deceleration module including instructions that cause the second processor to produce, based on the third signal, the fourth signal configured to cause the at least one braking actuator to cause, in response to the position of the braking operator interface being associated with causing the vehicle to move at a first rate of deceleration, the vehicle to move at a second rate of deceleration.

13. The system of claim 1, wherein:
the simulated path comprises a straight path, and
the actual path comprises a circular path.

14. The system of claim 13, wherein:
the first communications module further includes instructions to receive a third signal indicative of a measurement of a radius of the circular path, and
the instructions to produce the second signal include instructions to produce, based on the first signal and the third signal, the second signal.

15. The system of claim 14, wherein the instructions to receive the third signal include instructions to receive, from a server, the third signal.

16. The system of claim 14, wherein:
the straight path comprises a set of parallel lanes,
the circular path comprises a set of concentric circular lanes,
each circular lane, of the set of concentric circular lanes, is associated with a corresponding lane of the set of parallel lanes,
the simulated path, in response to changes of the position of the steering operator interface, further comprises a change from a first lane, of the set of parallel lanes, to a second lane of the set of parallel lanes,
the first memory further stores a radius determination module including instructions that cause the first processor to determine, based on the third signal, a measurement of a distance between the first lane and the second lane, and a direction of an initial change of the changes of the position of the steering operator interface, a measurement of a radius of a circular lane associated with the second lane, and
the instructions to produce the second signal include instructions to produce, based on the first signal and at least one of the third signal or the measurement of the radius of the circular lane associated with the second lane, the second signal.

17. The system of claim 1, wherein:
the simulated path comprises at least one simulated turn of a first specific angle,
the actual path comprises at least one actual turn of a second specific angle, the second specific angle being a multiple of the first specific angle, and
an actual turn, included in the actual path, is associated with a corresponding simulated turn included in the simulated path.

18. A method, comprising:
receiving, by a processor, a first signal indicative of a position of a steering operator interface;
producing, by the processor and based on the first signal, a second signal configured to cause a steering actuator for a wheel to produce, in response to the position of the steering operator interface being associated with causing a vehicle to move along a simulated path, a steering angle for an actual path along which the vehicle is intended to move; and
transmitting, by the processor, the second signal to the steering actuator to produce the steering angle to cause the vehicle to move along the actual path in a manner such that an occupant of the vehicle perceives that the vehicle is moving along the simulated path.

19. The method of claim 18, further comprising receiving, by the processor, a third signal configured to initiate the method.

20. A non-transitory computer-readable medium for causing an occupant of a vehicle to perceive that an actual path of the vehicle is a simulated path of the vehicle, the non-transitory computer-readable medium including instructions that, when executed by one or more processors, cause the one or more processors to:
receive a first signal indicative of a position of a steering operator interface;
produce, based on the first signal, a second signal configured to cause a steering actuator for a wheel to produce, in response to the position of the steering operator interface being associated with causing a vehicle to move along a simulated path, a steering angle for an actual path along which the vehicle is intended to move; and
transmit the second signal to the steering actuator to produce the steering angle to cause the vehicle to move along the actual path in a manner such that an occupant of the vehicle perceives that the vehicle is moving along the simulated path.
